(19) United States
(12) Patent Application Publication
(10) Pub. No.: US 2008/0247387 A1
(43) Pub. Date: Oct. 9, 2008

(54) Scalable hybrid switch fabric

(76) Inventor: David T. Neilson, Old Bridge, NJ (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/784,742

(22) Filed: Apr. 9, 2007

(51) Int. Cl. H04Q 11/00

(52) U.S. Cl. 370/386

(57) ABSTRACT

In one embodiment, a three-stage scalable hybrid switch fabric has an input stage with one or more electronic input crossbar switches, a middle stage, and an output stage with one or more electronic output crossbar switches. The middle stage has (1) tunable optical transmitters that convert electrical signals received from the input stage into optical signals having selectable wavelengths, (2) one or more passive, wavelength-dependent optical routers that route the optical signals received from the transmitters at input nodes to output nodes, each output node determined by the wavelength of the optical signal and possibly by the input node at which the optical signal is applied, and (3) optical receivers that convert the routed optical signals into electrical signals provided to the output stage. Each scaling increment includes (i) an input crossbar switch and its corresponding optical transmitters and (ii) an output crossbar switch and its corresponding optical receivers.

### BACKGROUND OF THE INVENTION

1. Field of the Invention

The invention relates to communication systems, and, in particular, to switch fabrics for switching and routing signals in communication systems.

2. Description of the Related Art

A switch fabric, also referred to as a switch or a router, receives a set of incoming signals and outputs a corresponding set of outgoing signals, where each incoming signal arrives at a different input port of the switch fabric and is presented as a corresponding outgoing signal at a different output port of the switch fabric.

FIG. 1 shows a block diagram of a prior-art switch fabric 100, whose architecture is based on the three-stage Clos network. Switch fabric 100 has N·L input ports, a first (or input) stage consisting of N (L×M) crossbar switches 102, a second (or middle) stage consisting of M (N×N) crossbar switches 104, and a third (or output) stage consisting of N(M×L) crossbar switches 106, and N·L output ports, where L≦M for a non-blocking fabric. Each input crossbar switch 102 can receive up to L incoming signals at its L input ports and route each received signal to a different one of the M middle crossbar switches 104. Each middle crossbar switch 104 can receive up to N different signals, one from each of the N different input crossbar switches 102, and routes each different signal to a different one of the N output crossbar switches 106. Each output crossbar switch 106 can receive up to M different signals, one from each of the M different middle crossbar switches 104 and presents each received signal as an outgoing signal at a different one of its L output ports.

Switch fabric 100 is strictly non-blocking for M≧2L−1; that is, switch fabric 100 is capable of routing an incoming signal received at any one of its input ports to become an outgoing signal at any one of its available output ports (i.e., an output port not already being used for a different outgoing signal) independent of how any other received incoming signals are being routed to other output ports. Switch fabric 100 may alternatively be reconfigurably non-blocking for L≦M≦2L−1; that is, switch fabric 100 is capable of being globally reconfigured to permit signals received at an input port to be routed to any one of its available output ports (i.e., an output port not already being used for a different outgoing signal), where the configuration depends on the other incoming signals' destination output ports. As used in this specification, the term “crossbar switch” refers to any suitable device that can route, in a non-blocking manner, a number of incoming signals into the same number of outgoing signals presented at different, desired output nodes of the switch.

In a conventional, all-electronic implementation of switch fabric 100, where each crossbar switch is an electronic crossbar switch and each signal is an electronic signal, the full architecture of FIG. 1 is completely deployed even if only a portion of the switch fabric's capacity is initially required for a particular application. It would be desirable, on the other hand, to provide a switch fabric having a scalable architecture in which only a portion of the hardware needs to be deployed if only a portion of the switch's capacity is initially required. Later, as more capacity is required, additional hardware can be deployed to scale the switch fabric to handle the additional load.

### SUMMARY OF THE INVENTION

In one embodiment, the invention is a multi-stage switch fabric comprising an input stage, a middle stage, and an output stage. The input stage is connected to receive a plurality of incoming signals at input ports of the switch fabric. The middle stage is connected to receive, from the input stage, a plurality of input electrical signals corresponding to the plurality of incoming signals. The middle stage comprises (1) a plurality of tunable optical transmitters, each connected to generate, based on an input electrical signal received from the input stage, an optical signal having a selectable wavelength, (2) one or more passive wavelength-dependent optical routers, each connected at input nodes to receive optical signals from corresponding tunable optical transmitters and route the optical signals to output nodes dependent on the wavelengths of the optical signals, and (3) a plurality of optical receivers, each connected to convert a routed optical signal received from the one or more optical routers into an output electrical signal. The output stage is connected to receive the output electrical signals from the optical receivers and present, at output ports of the switch fabric, a plurality of outgoing signals corresponding to the output electrical signals.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 shows a block diagram of a prior-art switch fabric;

FIG. 2 shows a block diagram of a scalable hybrid switch fabric according to one embodiment of the present invention;

FIG. 3 shows a block diagram of a partially deployed implementation of the switch fabric of FIG. 2.

### DETAILED DESCRIPTION

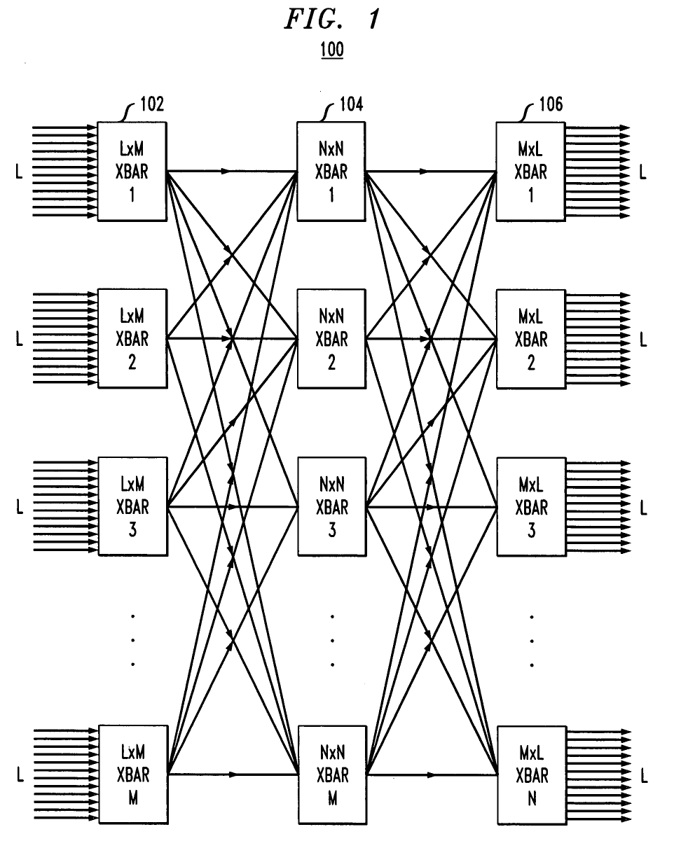

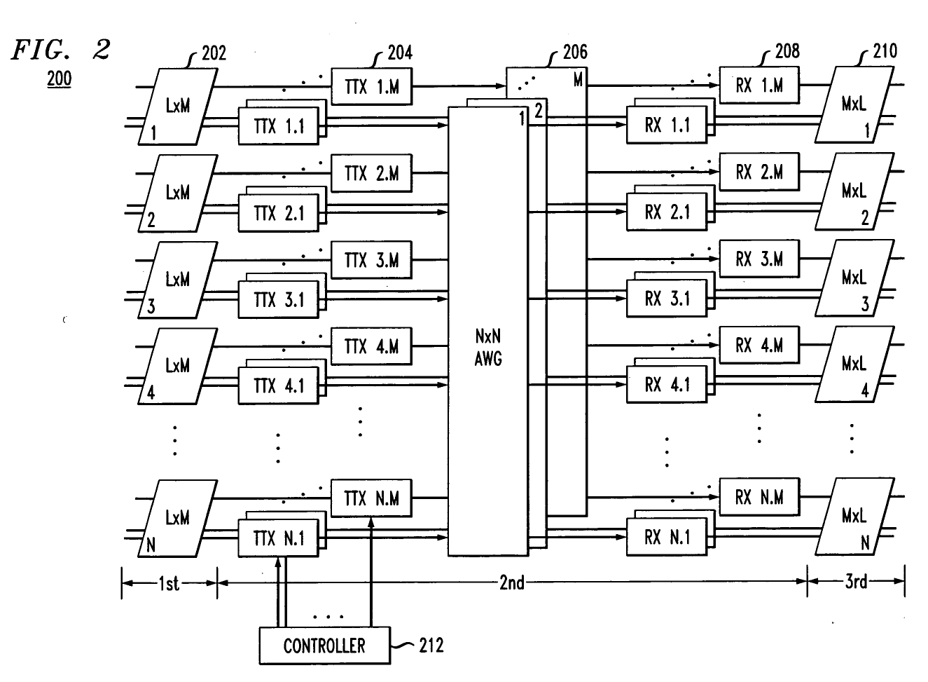

FIG. 2 shows a block diagram of a scalable hybrid switch fabric 200, according to one embodiment of the present invention. Like switch fabric 100 of FIG. 1, switch fabric 200 is a three-stage Clos network having N·L input ports, an input stage consisting of N (L×M) electronic crossbar switches 202, a middle stage consisting of M (N×N) crossbar switches, an output stage consisting of N (M×L) electronic crossbar switches 210, and N·L output ports. Unlike switch fabric 100, however, which has all-electronic middle crossbar switches 104, in switch fabric 200, each of the M middle crossbar switches includes N tunable optical transmitters 204, an (N×N) passive, wavelength-dependent optical router 206, and N optical receivers (e.g., photodiodes) 208. Each of the N transmitters 204 in a middle crossbar switch is connected to a different one of the N input crossbar switches 202, e.g., using a different single-mode fiber. Similarly, each of the N receivers 208 in a middle crossbar switch is connected to a different one of the N output crossbar switches 210, e.g., using a different single-mode fiber.

In addition to the three stages, switch fabric 200 has controller 212, which (1) selects a wavelength for each optical signal generated by the corresponding tunable optical transmitter 204 based on the desired output port for that optical signal and (2) controls (i.e., tunes) each tunable optical transmitter 204 to generate an optical signal having the corresponding selected wavelength.

In operation, an incoming signal received at an input port of one of the N electronic input crossbar switches 202 is routed in the electrical domain to one of the M transmitters 204 associated with that input crossbar switch. The transmitter converts the electronic signal into an optical signal having a particular wavelength selected by controller 212 and applies that optical signal to the corresponding input node of the corresponding passive, wavelength-dependent optical router 206. The optical router passively routes the optical signal to one of its N output nodes, where the particular output node depends on the wavelength of the optical signal. The routed optical signal is then applied to the optical receiver corresponding to that particular output node, where the optical signal is converted back to the electrical domain for application to the corresponding output crossbar switch 210, which presents the routed electronic signal as an outgoing signal at one of its L output ports.

As used in this specification, the term “hybrid” refers to the fact that switch fabric 200 operates in both the electrical domain and the optical domain, with input and output electronic crossbar switches 202 and 210 operating in the electrical domain, optical routers 206 operating in the optical domain, transmitters 204 functioning as electrical-to-optical (E-to-O) converters, and receivers 208 functioning as optical-to-electrical (O-to-E) converters.

In one implementation, each tunable optical transmitter 204 is a rapidly tunable-wavelength diode laser that generates an optical signal having a desired wavelength selected from (at least) N different wavelengths, where the optical signal is modulated according to the data encoded in the electronic signal received from the corresponding input crossbar switch 202. In alternative implementations, the tunable optical transmitters can be implemented using other suitable active devices that can generate optical signals having selectable wavelengths, such as an array of fixed-wavelength lasers and an electronic switching element to direct the data to the laser with the desired wavelength or an optical switching element to select the desired wavelength source from the array.

In one implementation, each passive, wavelength-dependent optical router 206 is an (N×N) arrayed waveguide grating (AWG) router, which can passively and simultaneously route up to N different received optical signals from the N input nodes to the N output nodes, where the output node for any given optical signal is a function of the input node at which the optical signal is applied and the wavelength of the optical signal. Note that two optical signals applied to two different input nodes and routed to two different output nodes can have different wavelengths or the same wavelength, depending on the particular nodes involved and the design of the AWG router.

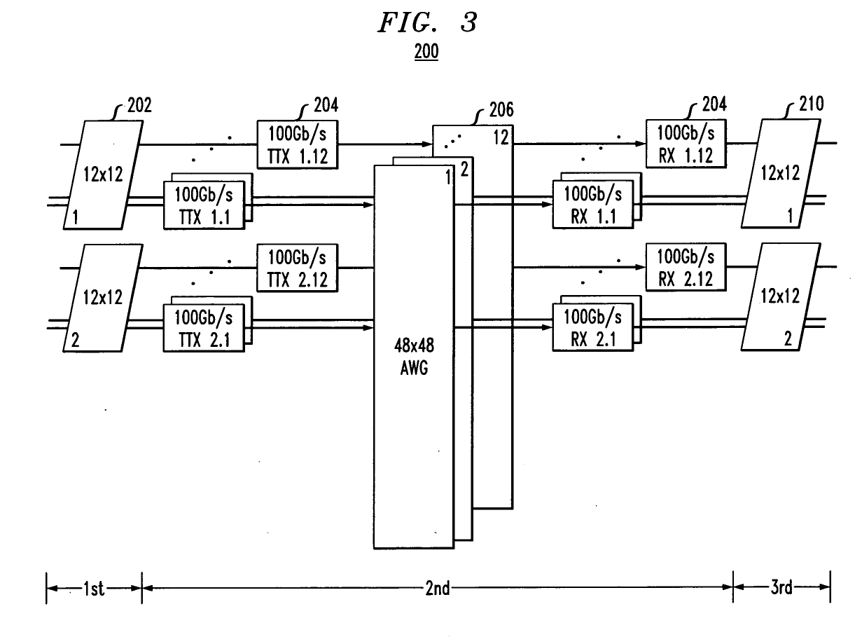

One of the advantages of switch fabric 200 is that it is scalable. FIG. 3 shows a block diagram of a partially deployed implementation of switch fabric 200. As shown in FIG. 3, although all M optical routers 206 are deployed, only 2 input crossbar switches 202, only 2M corresponding transmitters 204, only 2M corresponding receivers 208, and only 2 corresponding output crossbar switches 210 are deployed in this partial implementation. If and when additional capacity is required for the particular application, one or more additional input and output crossbar switches and their corresponding transmitters and receivers can be incrementally deployed as needed.

Note that, not only is switch fabric 200 scalable, but it also supports partially deployed implementations, such as the partial implementation of FIG. 3, that are non-blocking. Note, however, that not all partial or even complete implementations of switch fabric 200 necessarily need to be non-blocking and/or need to be operated in a non-blocking manner. For applications that do not require non-blocking operations, it may be “cheaper” to control the configuration of switch fabric 200 (e.g., the wavelengths selected for optical transmitters 204) using a non-blocking algorithm, where cheaper may mean one or more of lower cost, lower complexity, less power consumption, faster, smaller layout, and other type characteristics. For such blocking applications, other types of partial implementations are possible, including those having fewer than all M optical routers 206.

Another advantage of switch fabric 200 is that it supports efficient distributed implementations. In particular, due to the fact that signals are transmitted from transmitters 204 to optical routers 206 and from optical routers 206 to receivers 208 in the optical domain, switch fabric 200 can be efficiently implemented such that the elements of switch fabric 200 are not all co-located. In a typical implementation, each electronic input crossbar switch 202 is combined in a single linecard with a corresponding electronic output crossbar switch 210. Since signals are transmitted from each input crossbar switch 202 to its corresponding transmitters 204 and from each receiver 208 to its corresponding output crossbar switch 210 in the electrical domain, it may be efficient to implement the corresponding transmitters 204 and receivers 208 on the same single linecard as their corresponding input and output crossbar switches 202 and 210, respectively. However, different linecards and/or different optical routers 206 can be non-co-located, with signals being transmitted between the linecards and the optical routers in the optical domain.

For example, a single instance of switch fabric 200 can be efficiently implemented in a distributed manner across two or more different racks located within a single facility, where rack-to-rack communications occur in the optical domain within the middle stage. Depending on the particular implementation, the M optical routers 206 can be located in one or more racks. Similarly, the N linecards can be located in one or more racks that are either the same or different from the one or more racks having optical routers. In this example, the elements of switch fabric 200 are not all co-located because they are distributed over two or more different racks.

In another example, a single instance of switch fabric 200 can be efficiently implemented in a distributed manner across two or more different facilities located far apart (e.g., in different states), where facility-to-facility communications occur in the optical domain within the middle stage. Depending on the particular implementation, the M optical routers 206 can be located in one or more facilities. Similarly, the N linecards can be located in one or more facilities that are either the same or different from the one or more facilities having optical routers. In this example, the elements of switch fabric 200 are not all co-located because they are distributed over two or more different facilities.

Although the present invention has been described in the context of switch fabric 200 having optical routers 206 implemented using AWG routers, in alternative implementations, any suitable passive, wavelength-dependent optical router can be used, such as an optical add/drop multiplexer (OADM)-based wavelength-division multiplexing (WDM) transport network. The OADM WDM transport network can employ reconfigurable optical add/drop multiplexer (ROADM) elements that allow the wavelength-to-port assignments to be remotely reconfigured. Such a network may also employ wavelength-selective cross-connects (WSXCs), which are reconfigurable, passive, wavelength-dependent optical routers for transparently interconnecting two or more WDM transport systems. As used in this specification, the term “passive, wavelength-dependent optical router” refers to a static device or network that routes optical signals from input nodes to output nodes, where the output node for a particular optical signal is determined by the wavelength of the optical signal and possibly (although not necessarily, depending on the particular type of device used to implement the optical router) by the particular input node at which that optical signal is applied. To change the output node for a particular optical signal, only the wavelength and/or the input node need to be changed, while the configuration of the optical router itself remains unchanged (i.e., static). The reconfigurability of ROADM- and WSXC-based WDM transport networks allows for the provisioning of the paths of the fabric over which the switching occurs and is equivalent to assigning or configuring the fibers from the ports of the AWG to the transmitters and receivers. In the context of the present patent application, the ROADMs and WSCXs of such transport networks can be considered passive since the wavelength-dependent switching function of the cross-connects can be implemented without having to reconfigure the ROADMs and WSCXs. They do however allow the wavelength-dependent routing to be reconfigured if there are changes in the network topology or overall traffic demands.

In switch fabric 200, each tunable optical transmitter 204 functions as a (1×N) switch, where the selected output of the switch corresponds to the selected wavelength for the generated optical signal, and each optical router 206 functions as a passive (N×N) filter, where the filtering operation refers to the routing of each optical signal from an input node to a particular output node as a function of the wavelength of that optical signal. Optical routers 206 can be designed so that the same type of device capable of generating an optical signal having a wavelength selected from the same set of N wavelengths can be used for each tunable optical transmitter 204, where the relationship between wavelength and output port varies from input port to input port in a permutated way.

Depending on the particular implementation, the incoming signals received at the input ports of switch fabric 200 may be either electrical signals or optical signals or a mixture of both types of signals. If there are optical signals, then suitable O-to-E converters (not shown in FIG. 2) are implemented upstream of the corresponding electronic input crossbar switches 202. Similarly, the outgoing signals presented at the output ports of switch fabric 200 may be either electrical signals or optical signals or a mixture of both types of signals. If there are optical signals, then suitable E-to-O converters (not shown in FIG. 2) are implemented downstream of the corresponding electronic output crossbar switches 210.

Although the present invention has been described in the context of a three-stage switch fabric, in general, the present invention can be implemented in the context of multi-stage switch fabrics having three or more stages to allow greater scalability. For example, additional electronic cross-connect stages could be added at the input and output. Also, since the three-stage hybrid fabric implements a cross-connect and has electrical input and output ports, it can be used iteratively to replace the electronic cross-connects.

As used herein, the term “electrical” is synonymous with the term “electronic.” Thus, an electronic signal is the same thing as an electrical signal, and an electronic device is the same thing as an electrical device.

For purposes of this description, the terms “connect,” “connecting,” or “connected” refer to any manner known in the art or later developed in which energy is allowed to be transferred between two or more elements, and the interposition of one or more additional elements is contemplated, although not required. Conversely, the term “directly connected” implies the absence of such additional elements.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A multi-stage switch fabric comprising:
an input stage connected to receive a plurality of incoming signals at input ports of the switch fabric;
a middle stage connected to receive, from the input stage, a plurality of input electrical signals corresponding to the plurality of incoming signals, the middle stage comprising:
a plurality of tunable optical transmitters, each connected to generate, based on an input electrical signal received from the input stage, an optical signal having a selectable wavelength;
one or more passive wavelength-dependent optical routers, each connected at input nodes to receive optical signals from corresponding tunable optical transmitters and route the optical signals to output nodes dependent on the wavelengths of the optical signals; and
a plurality of optical receivers, each connected to convert a routed optical signal received from the one or more optical routers into an output electrical signal; and
an output stage connected to receive the output electrical signals from the optical receivers and present, at output ports of the switch fabric, a plurality of outgoing signals corresponding to the output electrical signals.

2. The invention of claim 1, wherein the switch fabric is scalable.

3. The invention of claim 2, wherein one or more partially deployed implementations of the switch fabric are non-blocking.

4. The invention of claim 2, wherein:
the input stage comprises one or more electronic input crossbar switches;
the output stage comprises one or more electronic output crossbar switches;
each scaling increment for the switch fabric comprises:
an electronic input crossbar switch;
a plurality of tunable optical transmitters corresponding to the electronic input crossbar switch;
an electronic output crossbar switch; and
a plurality of optical receivers corresponding to the electronic output crossbar switch.

5. The invention of claim 4, wherein each scaling increment is implemented in a single linecard.

6. The invention of claim 1, wherein elements within the switch fabric are not all co-located.

7. The invention of claim 6, wherein communications between non-co-located elements within the switch fabric occur in an optical domain within the middle stage.

8. The invention of claim 6, wherein the elements within the switch fabric are located in two or more cabinets in a single facility.

9. The invention of claim 6, wherein the elements within the switch fabric are located in two or more different facilities.

10. The invention of claim 1, wherein at least one tunable optical transmitter is a tunable laser.

11. The invention of claim 1, wherein at least one passive, wavelength-dependent optical router is an arrayed waveguide grating (AWG) router.

12. The invention of claim 1, wherein at least one passive, wavelength-dependent optical router is reconfigurable.

13. The invention of claim 1, wherein at least one passive, wavelength-dependent optical router is an optical add/drop multiplexer (OADM)-based wavelength-division multiplexing (WDM) transport network.

14. The invention of claim 13, wherein the OADM-based WDM transport network employs at least one of a reconfigurable OADM (ROADM) and a wavelength-selective cross-connect (WSXC).

15. The invention of claim 1, further comprising a controller adapted to select a wavelength for each input electrical signal based on a desired output node of a corresponding optical router and control the corresponding tunable optical transmitter to generate the corresponding optical signal having the selected wavelength.

16. The invention of claim 1, wherein at least one of the input stage and the output stage is a multi-stage switch.

17. The invention of claim 16, wherein the multi-stage switch is a hybrid three-stage switch.

18. The invention of claim 1, wherein:
the input stage comprises a plurality of electronic input crossbar switches;
the middle stage comprises a plurality of passive, wavelength-dependent optical routers; and
the output stage comprises a plurality of electronic output crossbar switches.

19. The invention of claim 18, wherein each tunable optical transmitter is a tunable laser and each optical router is an AWG router.

20. A method for routing, through a multi-stage switch fabric, incoming signals received at input ports of the switch fabric for presentation as outgoing signals at desired output ports of the switch fabric, the method comprising:
routing the incoming signals as input electrical signals through an input stage of the switch fabric;
selecting a wavelength for each routed input electrical signal as a function of a desired output port of the switch fabric;
converting each routed electrical signal into an optical signal having the corresponding selected wavelength;
routing each optical signal through a passive, wavelength-dependent optical router of a middle stage of the switch fabric;
converting each routed optical signal into an output electrical signal; and
routing the output electrical signals through an output stage of the switch fabric to present, at the desired output ports, the outgoing signals corresponding to the output electrical signals.

21. Apparatus for routing incoming signals received at input ports of the apparatus for presentation as outgoing signals at desired output ports of the apparatus, the apparatus comprising:
means for routing the incoming signals as input electrical signals through an input stage of the apparatus;
means for selecting a wavelength for each routed input electrical signal as a function of a desired output port of the apparatus;
means for converting each routed electrical signal into an optical signal having the corresponding selected wavelength;
means for passively routing each optical signal through a middle stage of the apparatus as a function of the selected wavelength;
means for converting each routed optical signal into an output electrical signal; and
means for routing the output electrical signals through an output stage of the apparatus to present, at the desired output ports, the outgoing signals corresponding to the output electrical signals.
